(19) United States
(12) Patent Application Publication
(10) Pub. No.: US 2011/0243628 A1
(43) Pub. Date: Oct. 6, 2011

(54) REUSABLE CLING DECALS FOR PLASTIC TOYS, BUILDING BRICKS, AND ACCESSORIES AND SYSTEM FOR CUSTOMIZING

(76) Inventors: Amy R. MacLean, Hartland, WI (US); Greyson A. MacLean, Hartland, WI (US)

(21) Appl. No.: 13/074,396

(22) Filed: Mar. 29, 2011

Related U.S. Application Data
(60) Provisional application No. 61/319,182, filed on Mar. 30, 2010.
(60) Provisional application No. 61/319,184, filed on Mar. 30, 2010.

(51) Int. Cl. B41J 11/44; B32B 3/14; B44C 1/17

(52) U.S. Cl. 400/76; 428/99

(57) ABSTRACT

A reusable decal system for use with building bricks, toys, and accessories made of plastic or other similar substance, which includes flexible cling decals and a non-porous backing sheet and a system for customizably designing and printing images on the cling decals. The cling decals are cut in a plurality of shapes and printed with a plurality of designs as to form windows, doors, signs, vehicle parts, animals, people, letters, numbers and symbols for the purpose of creating customized play sets, building brick creations, toys, and accessories. In use, the cling decals are peeled from a backing sheet and applied to the plastic building bricks, toys, or accessories in a variety of configurations. The cling decals can be reused in different or changed plastic building brick creations, other plastic toys, or other plastic accessories.

### CROSS-REFERENCE TO RELATED APPLICATIONS

The present patent application claims priority to U.S. Provisional Patent Application Ser. Nos. 61/319,182 and 61/319,184, filed Mar. 30, 2010, the entire contents of which are herein incorporated by reference.

### BACKGROUND

The present invention relates to a reusable cling decals for use in connection with building bricks, building brick creations, toys, as well as accessories made from plastic or similar material, and more particularly to the practice of affixing decals in a reusable and repositionable manner upon plastic toys for educational, entertainment, and decorative purposes.

### SUMMARY

The invention comprises reusable decals which include flexible cling shapes that are adhered, using some releasable cling mechanism, including but not limited to, any variety of relatively low-tack, pressure sensitive adhesive or mastic, or electrostatically or through some other releasable cling mechanism not requiring any variety of adhesive or mastic, to plastic building bricks, toys, and accessories. For clarity, the terms “cling” and “cling mechanism” and the like are referred to herein as including all such mechanisms, unless otherwise specified. The indicia are cut in a plurality of shapes and forms, and are printed on the outward facing side as to form windows, doors, signs, vehicle parts, animals, faces, clothing, people, letters, numbers and symbols for the purpose of creating customized play sets. In use, the indicia are peeled from a backing sheet and applied to the rigid plastic building blocks in a variety of configurations. The shapes can be reused in different or changed building block sets or on different plastic toys or accessories. The shapes can be cleaned of oil and dirt so as to revitalize their ability to stick to plastic surfaces. The cling shapes can be produced in pre-cut sheets for use with home printers and can be offered as customized collections of shapes through an online program.

The invention provides a flexible sheet of vinyl or similar material being die cut into a plurality of graphic symbol elements in the shapes of fictional or nonfictional characters, animals, windows, furniture, appliances, plants, lights, signs and the like to be arranged on plastic toys, such as building bricks, or accessories by use of static, or similar non-adhesive, cling. The invention elements are peeled from the substrate and adhered through the cling mechanism to the plastic surface. The invention elements can be removed, reused, rearranged, and repositioned to enable the user to create custom play elements on plastic toys. The invention elements can be removed, reused, rearranged, and repositioned to enable the user to create custom designs on plastic accessories such as sunglasses, bracelets, watches, headbands, and the like.

The invention increases the creative and educational options for popular interconnecting plastic building bricks. Interconnecting plastic building bricks are popular creative and educational toys because they can be used to build various shapes, structures, and people, which can then be disassembled and the same building bricks used to create other shapes, structures, and people. Current building brick sets are sold with traditional high-tack, non-releasable adhesive-backed stickers. Once the adhesive-backed stickers are connected to a creation comprised of interconnecting building bricks, neither the bricks nor the stickers can be easily reused. Even if the adhesive-backed sticker is limited in size as to affix to only one building brick, the adhesive-backed sticker cannot be easily removed. Generally speaking, once a traditional adhesive-backed sticker is attached to a brick, it remains part of that brick. Thus, using traditional high-tack, non-releasable, adhesive-backed stickers with interconnecting building brick creations reduces the creative options for the user. The invention elements allow for further customization of building brick creations, but in a way that increases the overall creative options for the user. This invention opens up a vast array of doors to the user not available in the prior art. This invention provides flexibility of play and settings, educational value, strategic possibilities and stimulation of cognitive and coordination skills far superior to any other game disclosed in the prior art.

In one embodiment, the invention elements can be used to customize plastic toys or plastic accessories like hair clips and bracelets. The advantage of using the invention elements is the ability to customize toys and accessories without permanently changing the appearance of the toy or accessory. The stickers comprising part of the invention can be printed with a variety of shapes, designs, names, or slogans to allow the temporary customization of toys and accessories.

The invention's shapes and printed components can be changed to allow for virtually limitless options. Furthermore, the invention can be offered with customized shapes, names, signs, etc. In one application, a customer can order sheets filled with shapes and designs the customer selects. In another application, customers can provide artwork, pictures, names, numbers, or slogans for inclusion in the shapes and designs. In another application, customers can select the colors used in the designs.

In another embodiment, the invention includes a system for customizing decals formed on a sheet of flexible cling material releasably adhered to a backing sheet. The sheet of flexible cling material is die-cut or kiss-cut into a variety of forms each customized in size and shape so as to fit on a plurality of predetermined plastic toys. The system includes a computer with a processor and a computer readable media storing instructions to be executed by the processor. When executed, the instructions cause the system to customize images to be printed on the sheet of flexible cling material. A first image, a first size for the first image, and a first shape for the first image are selected. The first size and shape are matched to a form from the variety of forms on the sheet of flexible cling material and the first image is printed on the matching form. In some embodiments, the image is selected at a first computer and printed by a remotely located decal customization system and shipped to a user of the first computer.

### BRIEF DESCRIPTION OF THE DRAWINGS

FIG. 1 illustrates the use of an invention cling decal with an interconnecting plastic building brick.

FIG. 2 illustrates a top plan view of a plurality of the invention cling decals, with one invention cling decal being pulled off of the substrate materials for use on plastic building bricks, toys, or accessories.

FIG. 3 is a top plan view of a plurality of invention cling decals formed in a variety of shapes in accordance with the invention and shown upon a common backing sheet.

FIG. 4 illustrates a side plan view of the invention cling decal flat against the surface of a plastic building brick, toy, or accessory

FIG. 5 as well as the invention cling decal of FIG. 4 being removed from the surface of a plastic building brick, toy, or accessory.

FIG. 6 illustrates the invention cling decal with a printed design on the top surface of the invention cling decal.

FIG. 7 is a front plan view of the invention cling decal being removed from the plastic building brick of FIG. 1.

FIG. 8 illustrates a front plan view of the invention cling decal of FIGS. 1 and 7 being reused on a different creation comprised of multiple interconnecting plastic building bricks.

FIG. 9 illustrates a front plan view of the use of the invention cling decal of FIGS. 1, 7, and 8 being reused on a plastic bracelet accessory.

FIG. 10 is a top plan view of an invention cling decal in a circle shape with a printed design on the top surface of the invention decal.

FIG. 11 is a schematic representation of a system for ordering, customizing and printing decals.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein are for the purpose of description and should not be regarded as limiting. The use of “including,” “comprising,” or “having” and variations thereof herein are meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings.

In addition, it should be understood that embodiments of the invention may include hardware, software, and electronic components or modules that, for purposes of discussion, may be illustrated and described as if the majority of the components were implemented solely in hardware. However, one of ordinary skill in the art, and based on a reading of this detailed description, would recognize that, in at least one embodiment, the electronic based aspects of the invention may be implemented in software (e.g., stored on non-transitory computer-readable medium). As such, it should be noted that a plurality of hardware and software based devices, as well as a plurality of different structural components may be utilized to implement the invention. Furthermore, and as described in subsequent paragraphs, the specific mechanical configurations illustrated in the drawings are intended to exemplify embodiments of the invention and that other alternative mechanical configurations are possible.

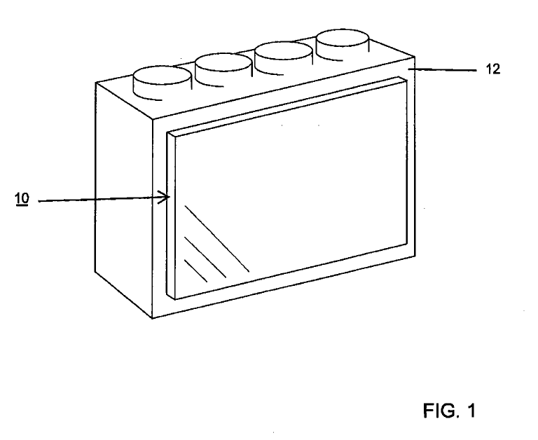

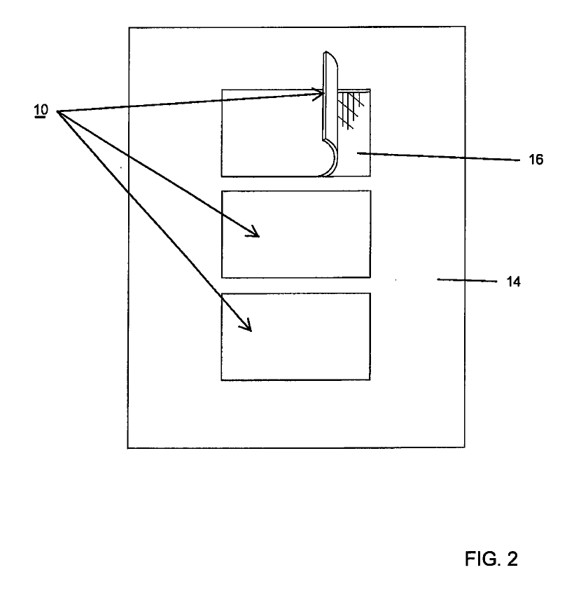

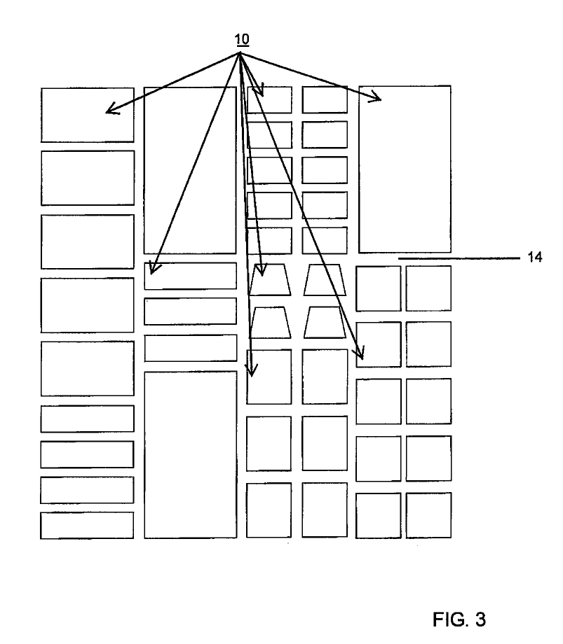

FIG. 1 shows the cling decal 10 of the invention affixed to the surface of a plastic building brick 12. The cling decals may be manufactured in a variety of ways. In one embodiment, each cling decal 10 is manufactured from an enlarged sheet of cling material 14 wherein this enlarged sheet is affixed to a backing sheet 16 of plasticized paper, plasticized cardboard, plastic, or other material upon which the cling material 14 can be affixed. The backing sheet 16 has a top release surface film of a plastic coating or the like chosen for removable attachment to the rear side of the cling material 14. The cling material 14 affixed to the backing sheet 16 is die cut by means of suitable cutting apparatus to form a plurality of shapes of selected size and shape, examples of which are viewed in FIGS. 2 and 3. This cutting procedure may be controlled to avoid cutting of the backing sheet 16, a technique known to those skilled in the art as “kiss cut,” thereby permitting the multiple cling decals 10 thereon to be packaged and marketed as a group. In one embodiment, the groups can be organized by theme, customized by customers ordering various collections of pre-designed shapes, or customized to incorporate names or words desired by an individual customer. In another embodiment, pre-cut sheets may be sold to be customized by the customers. While any individual cling decals 10 are not in use, they may conveniently be stored on the backing sheet 16 to which they readily adhere, thereby facilitating handling the unused cling decals 10.

As shown in FIGS. 2 and 3, cling decals 10 can be produced in a variety of shapes and can be produced with several cling decals 10 being die cut from a single sheet of cling material 14 on top of a backing sheet 16. The backing sheet 16 can be produced using plasticized paper, plastic, or plasticized cardboard, or any other material upon which the cling material 14 will adhere in a removable manner. As shown in FIG. 2, a selected cling decal 10 is easily peeled from the backing sheet 16 ready for use. The selected cling decal 10 can then be placed directly onto the toy, building brick, building brick creation, or accessory. A key feature of the invention is that the cling decals 10 affix to the plastic building brick 12 or other item without using glue or other mastic additives. The cling decal 10 thus provides a mechanism for customizing building bricks 12, building brick creations 24, toys, and accessories 26 without permanently changing the customized item.

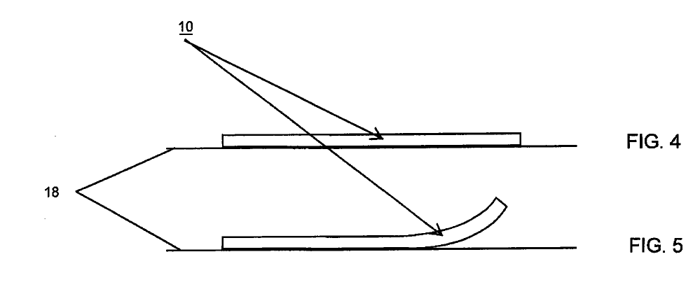

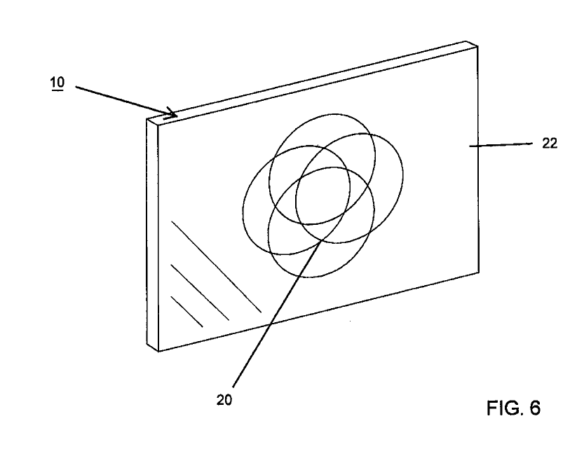

In FIG. 4, the cling decal 10 is seen from a side view, as attached to the surface 18 of a plastic building brick 12, toy, or accessory 26. FIG. 5 provides a side view of a cling decal 10 as it appears while being removed from the surface 18 of a plastic building brick 12, toy, or accessory 26.

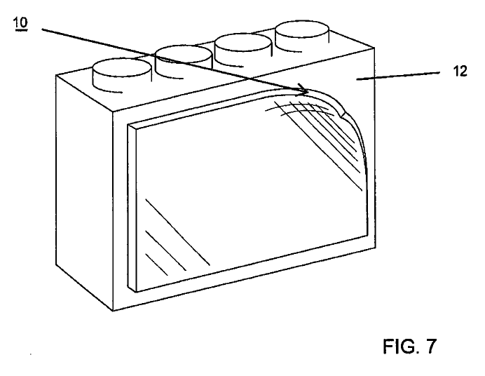

FIG. 6 shows the cling decal 10 of FIG. 1 with one of the limitless number of printed ornamentations 20 on the top surface 22 of the cling decal 10. In accordance with one aspect of the invention, the cling decals 10 on the backing sheet 16 have the decorative ornamentation applied to the top surface 22 thereof. This ornamentation 20, in a preferred form, is provided in different patterns, shapes, colors, and with words. The decorative ornamentation 20 is applied by use of ink selected from the general class of vinyl inks or other inks appropriate for the cling material 14, although alternative forms of decorative ornamentation may be applied. In any event, ornamentation 20 is applied to the top surface 22 of the cling decal 10 to avoid interference with rear side affixing to a toy, building brick 12, or accessory 26. The top surface 22 of the cling decal 10 can be printed with designs (as shown here), words, or pictures that can take the form of a name, sign, architectural feature, vehicle part, animal, person, face, clothing, accessory, or other desired indicia. After application of the decorative ornamentation 20, the top surface 22 of the cling decals 10 may be covered by a transparent surface layer. This surface layer may be used if doing so maintains the integrity of the underlying ornamentation and protects against smudging or other damage.

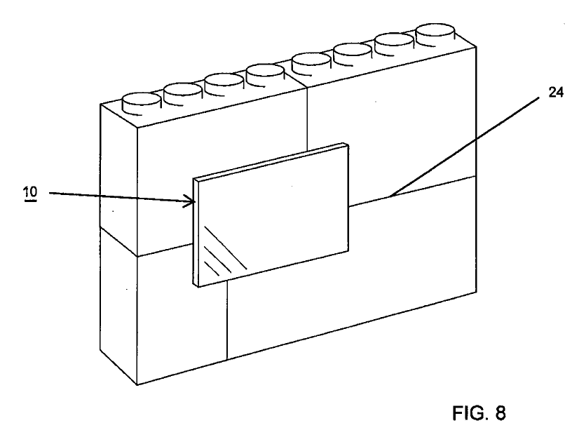

In addition to being reusable, the cling decals 10 are repositionable on the same or different surface. FIG. 7 demonstrates the cling decal 10 in use in FIG. 1 being removed from a plastic building brick 12. In FIG. 8, the cling decal 10 in use in FIG. 1, and removed in FIG. 7, is reused on a creation comprised of several plastic building bricks 24.

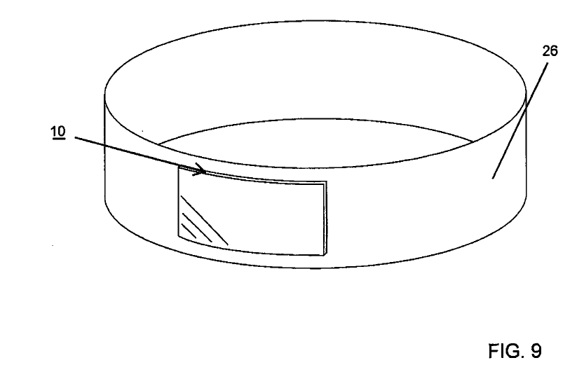

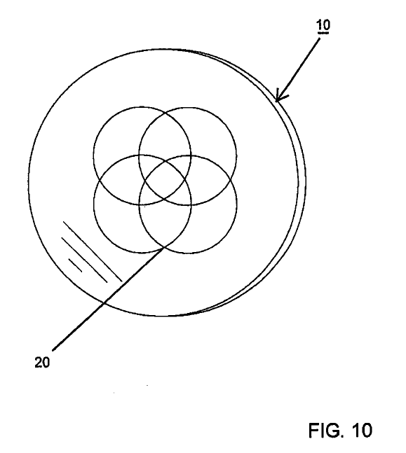

In FIG. 9, the cling decal 10 in use in FIGS. 1, 7, and 8 is again reused on a plastic bracelet accessory 26. The invention accommodates rapid interchanging of the cling decals 10 with other cling decals 10 and the rapid interchanging of plastic building bricks 12, toys, and accessories 26 onto which a given cling decal 10 is attached. That is, a cling decal 10 can be peeled from the customized item quickly and easily and without leaving unsightly residue on the customized item. The removed cling decal 10 can be returned to its original site on the backing sheet 16, whereupon a different cling decal 10 can be selected from the backing sheet 16 for mounting onto the customized building brick 10, toy, or accessory 26. In addition, the removed cling decal 10 can be attached to another building brick 12, toy, or accessory 26. In this manner, the decorative appearance of the combined toy, building brick 12, or accessory 26 and cling decal 10 can be customized and changed to suit the desires or moods of the individual. Furthermore, the cling decals 10 can be changed and combined to suit the user's imagination.

FIG. 10 demonstrates on of many alternative shapes for the cling decal 10 with a design ornamentation 20 printed on the top surface 22 of the cling decal 10. The material used for the cling decals 10 can be die cut into any variety of shapes and printed with any variety of designs, words, or pictures, to permit their use as faces, clothing, windows, doors, architectural features, slogans, signs, decorative elements, flowers, trees, skid marks, engines, mailboxes, or any other visual element that can be utilized in conjunction with plastic building bricks 12, toys, or accessories 26.

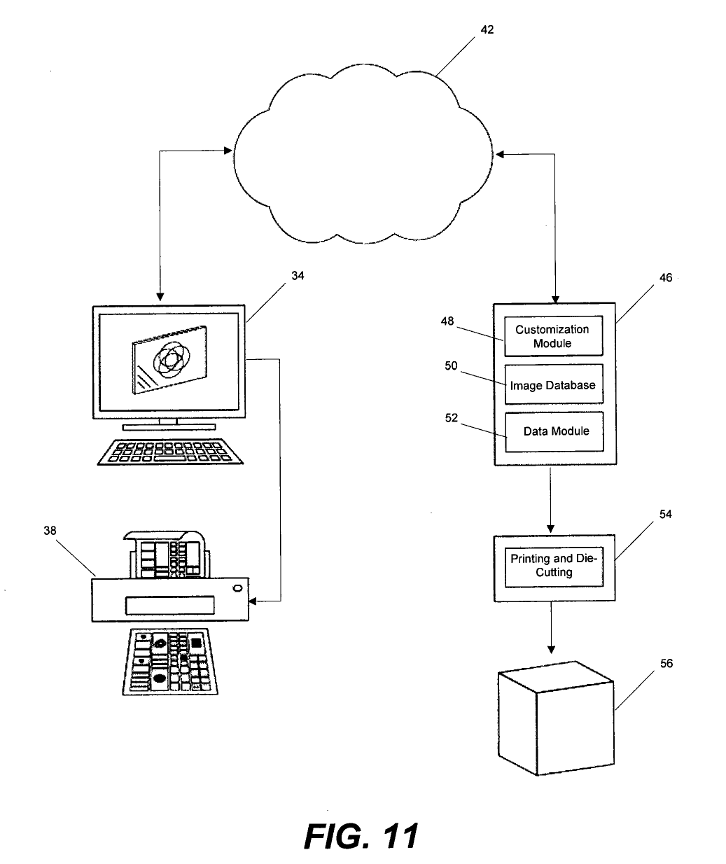

FIG. 11 is a schematic representation of a system 30 for ordering, customizing and printing decals formed on a sheet of flexible cling material releasably adhered to a backing sheet, which is die-cut or kiss-cut into a variety of forms, customized in size and shape so as to fit on a plurality of predetermined plastic toys. As shown in FIG. 11, the system 30 includes a computer 34 including a processor, computer-readable media, and an input/output interface. The processor, computer-readable media, and input/output interface are connected by one or more connections, such as a system bus. It should be understood that although only one processor, computer-readable media module, and input/output interface are described in connection with FIG. 11, the system 30, and any computers specified therein, can include multiple processors, computer-readable media modules, and input/output interfaces. Also, the functionality provided by the system 30 can be distributed among or accommodate multiple computers or systems or can be combined with other computers or systems. The computer-readable media can include non-transitory computer readable medium and can include volatile memory, non-volatile memory, or a combination thereof. In some embodiments, the computer-readable media includes a disk drive or other types of large capacity storage mechanism.

The input/output interface of the computer 34 is connected locally to a printer 38 for locally printing decals ordered or customized through the system 30. The input/output interface of the computer 34 is also connected to a network 42. As is commonly known in the art, the input/output connections of the computer 34 may be wired or wireless, and the network can be any form of network, including a LAN, WAN, internet, extranet, or other form of network.

Also shown in FIG. 11 is a decal customization specialty purpose computer 46 connectable via the network 42. The specialty purpose computer is a remotely located decal customization system and includes a processor, computer readable media and input/output interfaces (not shown). The input/output interface allows communication between devices, such as computer 34, on the network, and specialty purpose computer 46.

The instructions stored in the computer-readable media can include various components or modules configured to perform particular functionality when executed by the processor of computer 46. For example, the computer-readable media can include a decal customization module 48 and a decal image database 50. The decal image database includes a set of images stored therein for selection to print on a selected decal. The customization module 48 allows selection of images from the image database 50 to print on a decal or set of decals. Alternatively, the customization module 48 allows uploading of images over the network 42 for printing on the decal or set of decals. The customization module 48 includes computer executable instructions to format the images for printing on the forms. If the images selected are inappropriate for the decal selected, i.e., the images cannot be formatted to print on the decal, then, the customization module 48 generates a message sent via the network 42 to computer 34 indicating that the selected image cannot be formatted to print on the decal.

Once formatted, the image can be sent back from computer 46 to computer 34 to print the images on a pre-cut decal sheet using printer 38. In another embodiment, the customization module can be stored locally on computer 34 to allow immediate printing of the decal on printer 38. In yet another embodiment, the computer 46 includes a data module 52 for inputting user information. The formatted images can be sent to a printing and die-cutting machine 54 along with the user information. With this information, the die cut machine 54 can automatically print and package the customized decals (illustrated as package 56) for mailing to the user using appropriate means such as mail, etc. In yet another embodiment, the computer 46 includes a forms customization module operable in connection with the image database and/or image customization module to format the shape of the forms so that the sheet is die cut in a way that fits the images requested by the user. In still another embodiment, the computer 46 generates an image of the proposed sheet prior to die cutting or printing from computer 34, and transmits the image to computer 34 for display thereon, so that the user can view the layout of forms on the sheet prior to printing and/or die cutting.

Various features and advantages of the invention are set forth in the following claims.

What is claimed is:

1. A sheet of reusable cling decals comprising:
a sheet of flexible cling material releasably adhered to a backing sheet, said sheet of flexible cling material being die-cut or kiss-cut into a variety of forms, customized in size and shape so as to fit on a plurality of predetermined plastic toys;
wherein the forms of flexible cling material are manually peelable from the backing sheet and removably, repositionably and reattachably adhered to the plastic toys; and are subsequently peelable from the plastic toys and electrostatically, removably, repositionably and reattachably adhered to another plastic toy.

2. An apparatus as set forth in claim 1, wherein the flexible cling material is polyvinyl chloride (PVC).

3. An apparatus as set forth in claim 1, wherein the flexible cling material is static cling vinyl.

4. An apparatus as set forth in claim 1, wherein the flexible cling material can be cleaned of oil and dirt so as to revitalize its ability to cling to relatively smooth non-porous plastic surfaces.

5. An apparatus as set forth in claim 1, wherein shapes are printed on the outward facing side of the forms as to form windows, doors, signs, vehicle parts, animals, faces, clothing, people, letters, numbers and symbols.

6. An apparatus as set forth in claim 1, wherein the forms are of such size and dimension as to fit on standard sizes of plastic building blocks.

7. An apparatus as set forth in claim 1, wherein the relatively smooth non-porous plastic toy is a building block.

8. An apparatus as set forth in claim 1, wherein the relatively smooth non-porous plastic toy is a house, building or other similar structure.

9. An apparatus as set forth in claim 1, wherein the relatively smooth non-porous plastic toy consists of accessories such as sunglasses, bracelets, watches, headbands and the like.

10. An apparatus as set forth in claim 1, wherein the sheet of die-cut or kiss-cut flexible cling material is clear, and without any image printed thereon, so that consumers can customize the forms with selected indicia using a printer.

11. A system for customizing decals, the system comprising:
a computer including a processor and a computer readable media in communication with a processor, the computer readable media storing specialty purpose instructions that, when executed by the processor, cause the system to customize images to be printed on a sheet of flexible cling material releasably adhered to a backing sheet, the sheet of flexible cling material being die-cut or kiss-cut into a variety of forms by
selecting a first image, a first size for the first image, and a first shape for the first image;
matching the first size and the first shape with a first form from the variety of forms on the sheet of flexible cling material; and
printing the first image on the first form of the sheet of flexible cling material.

12. The system of claim 11, wherein the computer further includes an image database, storing images to be printed on the forms.

13. The system of claim 11, wherein the computer further includes an image customization module for allowing users to upload custom images to the computer, the image customization module including computer implemented instructions to format the custom images to be printed on the forms.

14. The system of claim 11, wherein the computer further includes a user information module, for storing user information allowing transmission of formatted images to the user for printing on a second computer.

15. The system of claim 11, wherein the computer further comprises an input/output interface connectable to a network, so that users of the system can access the computer via the network to generate custom decals from the forms.

16. A computer-implemented method for customizing decals formed on a sheet of flexible cling material releasably adhered to a backing sheet, said sheet of flexible cling material being die-cut or kiss-cut into a variety of forms, customized in size and shape so as to fit on a plurality of predetermined plastic toys, the method comprising:
selecting a first image, a first shape, and a first size;
selecting a second image, a second shape, and a second size; and
printing the first image and the second image on the sheet of flexible cling material,
wherein the first image is printed on a first form on the sheet of flexible cling material corresponding to the first shape and the first size, and the second image is printed on a second form on the sheet of flexible cling material corresponding to the second shape and the second size.

17. The method of claim 16, wherein the first image is selected from an image data base stored on a computer readable medium, the image database storing a plurality of images to be printed on the forms.

18. The method of claim 16, further comprising uploading a custom image to a computer; and formatting the custom image to be printed on one of the variety of forms, wherein the act of selecting a first image, a first shape, and a first size includes selecting the formatted custom image.

19. The method of claim 18, further comprising storing user information on a first computer; and transmitting the formatted custom image to a second computer, wherein the act of printing the first image and the second image is performed at the second computer.

20. The method of claim 16, further comprising accessing a decal customization system from a computer through a network, wherein the acts of selecting the first image and selecting the second image include accessing an image database stored on the decal customization system from the computer.

21. The method of claim 20, wherein the act of printing the first image and the second image includes printing the first image and the second image at a printer connected to the decal customization system, and the method further comprising
receiving shipping information from a user through the computer; and
shipping the sheet of flexible cling material to the user based on the shipping information.

22. Non-transitory computer-readable medium encoded with a plurality of processor-executable instructions for customizing decals formed on a sheet of flexible cling material releasably adhered to a backing sheet, said sheet of flexible cling material being die-cut or kiss-cut into a variety of forms, customized in size and shape so as to fit on a plurality of predetermined plastic toys, the instructions comprising:
an image selection module for selecting a first image, a first shape for the first image, a first size for the first image, a second image, a second shape for the second image, and a second size for the second image;
a printing module for matching the first shape and the first size with a first form of the variety of forms, matching the second shape and the second size with a second form of the variety of forms, and printing the first image and the second image on the sheet of flexible cling material, wherein the first image is printed on the first form of the sheet of flexible cling material and the second image is printed on a second form of the sheet of flexible cling material.

23. The non-transitory computer-readable medium of claim 22, wherein the image selection module accesses an image database, the image database storing a plurality of images to be printed on the forms, and wherein the first image is selected from the image database.

24. The non-transitory computer-readable medium of claim 22, wherein the image selection module uploads a custom image to be printed on one of the variety of forms and formats the custom image to be printed on one of the variety of forms.

25. The non-transitory computer-readable medium of claim 22, the instructions further comprising a user information module for storing user information and using the stored user information to transmit formatted images to a second computer.

26. The non-transitory computer-readable medium of claim 25, the instructions further comprising a remote print module for instructing a remote decal customization system to print the first image and the second image on the sheet of flexible cling material and to ship the sheet of flexible cling material to the user based on the stored user information.
